(19) United States
(12) Patent Application Publication
(10) Pub. No.: US 2020/0141268 A1
(43) Pub. Date: May 7, 2020

(54) Frangible Gas Turbine Engine Airfoil

(71) Applicant: General Electric Company, Schenectady, NY (US)

(72) Inventors: Nicholas Joseph Kray, Mason, OH (US); Nitesh Jain, Bangalore (IN)

(21) Appl. No.: 16/177,732

(22) Filed: Nov. 1, 2018

(51) Int. Cl. F01D 21/04; F01D 5/28

(52) U.S. Cl. CPC F01D 21/045; F01D 5/282; F05D 2300/6034; F05D 2260/311; F05D 2240/30

(57) ABSTRACT

An airfoil including a plurality of spanwise fibers extending between the root and the tip and arranged between the leading edge and the trailing edge. The airfoil includes a matrix material surrounding and securing the plurality of spanwise fibers. The airfoil includes a residual airfoil portion extending between the leading edge and the trailing edge and extending between the root and a frangible line along the span. The residual airfoil portion includes a first portion of the plurality spanwise fibers including a first stiffness. The airfoil further includes a frangible airfoil portion extending between the leading edge and the trailing edge and extending between the tip and the frangible line. The frangible airfoil portion includes a second portion of the plurality of spanwise fibers including a second stiffness less than the first stiffness. The residual airfoil portion meets the frangible airfoil portion at the frangible line.

### FIELD

The present subject matter relates generally to airfoils and, more particularly, to frangible airfoils for gas turbine engines including a fiber weave arrangement.

### BACKGROUND

Airfoils used in aircraft engines, such as fan blades of a gas turbine engine, can be susceptible to extreme loading events. For instance, a fan blade might strike a bird that is ingested into the engine, or a blade-out occurrence may arise wherein one of the fan blades is severed from a rotor disk. If the impact is large enough, a fan blade may break apart into one or more shards before traveling downstream through the engine.

Gas turbine engines, such as turbofans, generally include fan cases surrounding a fan assembly including the fan blades. The fan cases are generally configured to withstand an impact of the fan blades due to adverse engine conditions resulting in a failure mode, such as foreign object damage, hard rubs due to excessive or extreme unbalance or fan rotor oscillations, or fan blade liberation. However, such airfoil configurations generally increase the weight of the fan case, thereby increasing the weight of the engine and aircraft and reducing performance and efficiency.

Known fan cases generally include frangible structures, such as honeycombs or trench-filler material, configured to mitigate load transfer to and through the fan case. However, this approach is generally costly. Furthermore, this approach may result in larger, heavier, less efficient fan cases. Still further, this approach may not address issues relating to fan rotor unbalance following deformation or liberation of one or several airfoils such as fan blades.

As such, there is a need for an airfoil that enables a controlled and consistent failure mode of the airfoil that may enable reducing a cost, weight, and load transfer to a surrounding casing.

### BRIEF DESCRIPTION

Aspects and advantages will be set forth in part in the following description, or may be obvious from the description, or may be learned through practice of the invention.

In one aspect, the present subject matter is directed to an airfoil defining a span extending between a root and a tip and a chord at each point along the span extending between a leading edge and a trailing edge. The airfoil includes a plurality of spanwise fibers extending between the root and the tip and arranged between the leading edge and the trailing edge. The airfoil further includes a matrix material surrounding the plurality of spanwise fibers. As such, the matrix material secures the plurality of spanwise fibers. The airfoil includes a residual airfoil portion extending between the leading edge and the trailing edge and extending between the root and a frangible line along the span. The residual airfoil portion includes a first portion of the plurality spanwise fibers. The first portion of the plurality of spanwise fibers defines a first stiffness. The airfoil further includes a frangible airfoil portion extending between the leading edge and the trailing edge and extending between the tip and the frangible line along the span. The frangible airfoil portion includes a second portion of the plurality of spanwise fibers. The second portion of the plurality of spanwise fibers defines a second stiffness less than the first stiffness. Moreover, the residual airfoil portion meets the frangible airfoil portion at the frangible line. As such, the frangible line extends at least partially along the chord at a point along the span of the frangible line.

In one embodiment, the frangible airfoil portion deforms or partially or fully detaches relative to the residual airfoil portion at the frangible line following an event creating imbalance. In another embodiment, the airfoil may be a fan blade of a gas turbine engine. In an additional embodiment, the frangible line may extend parallel to the chord at the point along the span of the frangible line. In a further embodiment, the frangible line may extend at least partially along the span. In one embodiment, the frangible airfoil portion may extend along at least 10% of the span from the tip. In another embodiment, the frangible airfoil portion may extend along at least 15% but less than 50% of the span from the tip.

In another embodiment, the airfoil may further include a plurality of chordwise fibers extending between the leading edge and the trailing edge and arranged between the root and the tip. The matrix material may further surround and secure the plurality of chordwise fibers. In one such embodiment, the plurality of chordwise fibers may be interwoven with the plurality of spanwise fibers to define a woven fiber arrangement. In a further embodiment, at least one of the plurality of spanwise fibers may extend through the frangible line.

In one particular embodiment, at least one of the first portion of the plurality of spanwise fibers may define a first minimum fiber stiffness. In such an embodiment, at least one of the second portion of the plurality spanwise fibers may define a second minimum fiber stiffness less than the first minimum fiber stiffness. In another embodiment, the first portion of the plurality of spanwise fibers may each define the first fiber stiffness. Further, the second portion of the plurality of spanwise fibers may each define the second fiber stiffness less than the first fiber stiffness. In another embodiment, at least one of the first portion of the plurality of spanwise fibers may include a composite fiber. In such an embodiment, at least one of the second portion of the plurality of spanwise fibers may include a glass or metal fiber.

In a further embodiment, the first plurality of spanwise fibers may be arranged in a plurality of first toes, and the second plurality of spanwise fibers may be arranged in a plurality of second toes. Moreover, a first fiber count of at least one of the first toes may be higher than a second fiber count of at least one of the second toes. In one such embodiment, the first fiber count may be at least six thousand fibers per toe, and the second fiber count may be less than six thousand fibers per toe.

In another aspect, the present subject matter is directed to a gas turbine engine defining a central axis. The gas turbine engine includes an engine shaft extending along the central axis, a compressor attached to the engine shaft and extending radially about the central axis, a combustor positioned downstream of the compressor to receive a compressed fluid therefrom, a turbine mounted on the engine shaft downstream of the combustor to provide a rotational force to the compressor, and a plurality of airfoils operably connected to the engine shaft. Each of the plurality of airfoils defines a span extending between a root and a tip and a chord at each point along the span extending between a leading edge and a trailing edge.

Each airfoil includes a plurality of spanwise fibers extending between the root and the tip and arranged between the leading edge and the trailing edge. Each airfoil further includes a matrix material surrounding the plurality of spanwise fibers. As such, the matrix material secures the plurality of spanwise fibers. Each airfoil includes a residual airfoil portion extending between the leading edge and the trailing edge and extending between the root and a frangible line along the span. The residual airfoil portion includes a first portion of the plurality spanwise fibers. The first portion of the plurality of spanwise fibers defines a first stiffness. Each airfoil further includes a frangible airfoil portion extending between the leading edge and the trailing edge and extending between the tip and the frangible line along the span. The frangible airfoil portion includes a second portion of the plurality of spanwise fibers. The second portion of the plurality of spanwise fibers defines a second stiffness less than the first stiffness. Moreover, the residual airfoil portion meets the frangible airfoil portion at the frangible line. As such, the frangible line extends at least partially along the chord at a point along the span of the frangible line.

In one embodiment, the gas turbine engine may further include a fan section including the plurality of airfoils configured as fan blades. It should be further understood that the gas turbine engine may further include any of the additional features as described herein.

These and other features, aspects and advantages will become better understood with reference to the following description and appended claims. The accompanying drawings, which are incorporated in and constitute a part of this specification, illustrate embodiments of the invention and, together with the description, serve to explain certain principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended FIGS., in which:

FIG. 1 illustrates a cross-sectional view of one embodiment of a gas turbine engine that may be utilized within an aircraft in accordance with aspects of the present subject matter, particularly illustrating the gas turbine engine configured as a high-bypass turbofan jet engine;

FIG. 2 illustrates a cross-sectional view of the fan section of FIG. 1 in accordance with aspects of the present subject matter, particularly illustrating a fan blade of the fan section;

FIG. 3 illustrates a fan blade of the fan section of FIGS. 1 and 2 in accordance with aspects of the present subject matter, particularly illustrating a frangible airfoil portion and a residual airfoil portion;

FIG. 4 illustrates one embodiment of spanwise fibers in accordance with aspects of the present subject matter, particularly illustrating the spanwise fibers configured in a woven fiber arrangement;

FIG. 5 illustrates one embodiment of a frangible airfoil portion in accordance with aspects of the present subject matter, particularly illustrating a cross-section of the airfoil along a chord C and a span S of the airfoil; and

FIG. 6 illustrates another view of the frangible airfoil portion in accordance with aspects of the present subject matter, particularly illustrating a cross-section of the airfoil 62 along the span S and the chord C of the airfoil.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The terms “communicate,” “communicating,” “communicative,” and the like refer to both direct communication as well as indirect communication such as through a memory system or another intermediary system.

A frangible airfoil for gas turbine engines is generally provided. The airfoil may include a plurality of spanwise fibers extending between a root and a tip and arranged between a leading edge to a trailing edge. Further, the airfoil may define a frangible line separating a frangible airfoil portion and a residual airfoil portion. The residual airfoil portion may extend between the frangible line and an airfoil root along a span. Further, the airfoil may define the frangible airfoil portion extending between the frangible line and the tip along the span. The frangible airfoil portion positioned radially outward from the frangible line may include a reduced bending stiffness such that the frangible airfoil portion may break-off or bend during a failure mode of the airfoil. More particularly, the residual airfoil portion may include a first portion of the plurality spanwise fibers defining a first stiffness. The frangible airfoil portion may include a second portion of the plurality of spanwise fibers defining a second stiffness less than the first stiffness. As such, the frangible airfoil portion may define a reduced bending stiffness along the span relative to the residual airfoil portion. The embodiments generally shown and described herein may enable a controlled and consistent failure of the airfoil, such as a fan blade, following a failure event, such as a hard rub against a surrounding fan case. The embodiments generally described herein enable the airfoil to deform or detach at a desired span of the airfoil to mitigate load transfer to a surrounding casing. The embodiments generally provided herein may further enable the airfoil to deform or detach such that excessive or extreme unbalance of the fan rotor may be reduced following a failure event, such as airfoil liberation, foreign object damage (e.g., bird strikes, icing, etc.), or loss of lube or damper to a bearing assembly.

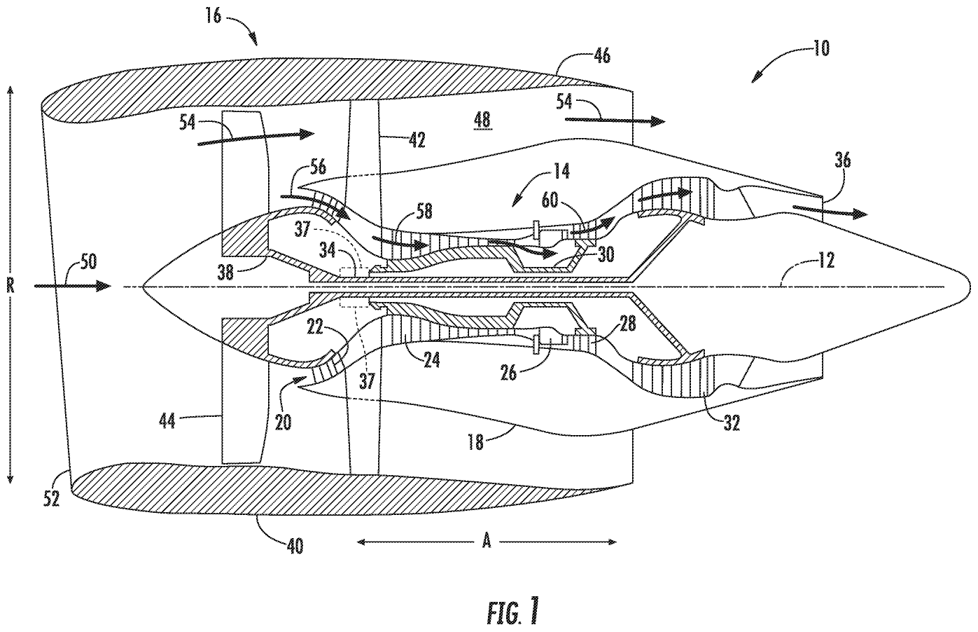

Referring now to the drawings, FIG. 1 illustrates a cross-sectional view of one embodiment of a gas turbine engine 10 that may be utilized within an aircraft in accordance with aspects of the present subject matter. More particularly, for the embodiment of FIG. 1, the gas turbine engine 10 is a high-bypass turbofan jet engine, with the gas turbine engine 10 being shown having a longitudinal or axial centerline axis 12 extending therethrough along an axial direction A for reference purposes. The gas turbine engine 10 further defines a radial direction R extended from the centerline 12. Although an exemplary turbofan embodiment is shown, it is anticipated that the present disclosure can be equally applicable to turbomachinery in general, such as an open rotor, a turboshaft, turbojet, or a turboprop configuration, including marine and industrial turbine engines and auxiliary power units.

In general, the gas turbine engine 10 includes a core gas turbine engine (indicated generally by reference character 14) and a fan section 16 positioned upstream thereof. The core engine 14 generally includes a substantially tubular outer casing 18 that defines an annular inlet 20. In addition, the outer casing 18 may further enclose and support a low pressure (LP) compressor 22 for increasing the pressure of the air that enters the core engine 14 to a first pressure level. A multi-stage, axial-flow high pressure (HP) compressor 24 may then receive the pressurized air from the LP compressor 22 and further increase the pressure of such air. The pressurized air exiting the HP compressor 24 may then flow to a combustor 26 within which fuel is injected into the flow of pressurized air, with the resulting mixture being combusted within the combustor 26. The high energy combustion products 60 are directed from the combustor 26 along the hot gas path of the gas turbine engine 10 to a high pressure (HP) turbine 28 for driving the HP compressor 24 via a high pressure (HP) shaft or spool 30, and then to a low pressure (LP) turbine 32 for driving the LP compressor 22 and fan section 16 via a low pressure (LP) drive shaft or spool 34 that is generally coaxial with HP shaft 30. After driving each of turbines 28 and 32, the combustion products 60 may be expelled from the core engine 14 via an exhaust nozzle 36 to provide propulsive jet thrust.

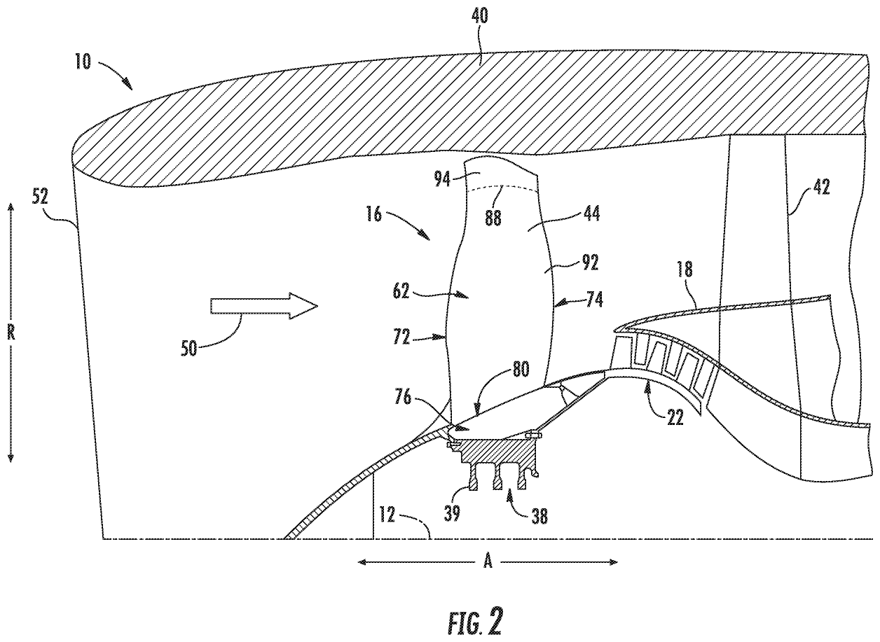

Additionally, as shown in FIGS. 1 and 2, the fan section 16 of the gas turbine engine 10 generally includes a rotatable, axial-flow fan rotor 38 configured to be surrounded by an annular fan casing 40. In particular embodiments, the LP shaft 34 may be connected directly to the fan rotor 38 or rotor disk 39, such as in a direct-drive configuration. In alternative configurations, the LP shaft 34 may be connected to the fan rotor 38 via a speed reduction device 37 such as a reduction gear gearbox in an indirect-drive or geared-drive configuration. Such speed reduction devices may be included between any suitable shafts/spools within the gas turbine engine 10 as desired or required.

It should be appreciated by those of ordinary skill in the art that the fan casing 40 may be configured to be supported relative to the core engine 14 by a plurality of substantially radially-extending, circumferentially-spaced outlet guide vanes 42. As such, the fan casing 40 may enclose the fan rotor 38 and its corresponding fan rotor blades (fan blades 44). Moreover, a downstream section 46 of the fan casing 40 may extend over an outer portion of the core engine 14 so as to define a secondary, or by-pass, airflow conduit 48 that provides additional propulsive jet thrust.

During operation of the gas turbine engine 10, it should be appreciated that an initial airflow (indicated by arrow 50) may enter the gas turbine engine 10 through an associated inlet 52 of the fan casing 40. The air flow 50 then passes through the fan blades 44 and splits into a first compressed air flow (indicated by arrow 54) that moves through the by-pass conduit 48 and a second compressed air flow (indicated by arrow 56) which enters the LP compressor 22. The pressure of the second compressed air flow 56 is then increased and enters the HP compressor 24 (as indicated by arrow 58). After mixing with fuel and being combusted within the combustor 26, the combustion products 60 exit the combustor 26 and flow through the HP turbine 28. Thereafter, the combustion products 60 flow through the LP turbine 32 and exit the exhaust nozzle 36 to provide thrust for the gas turbine engine 10.

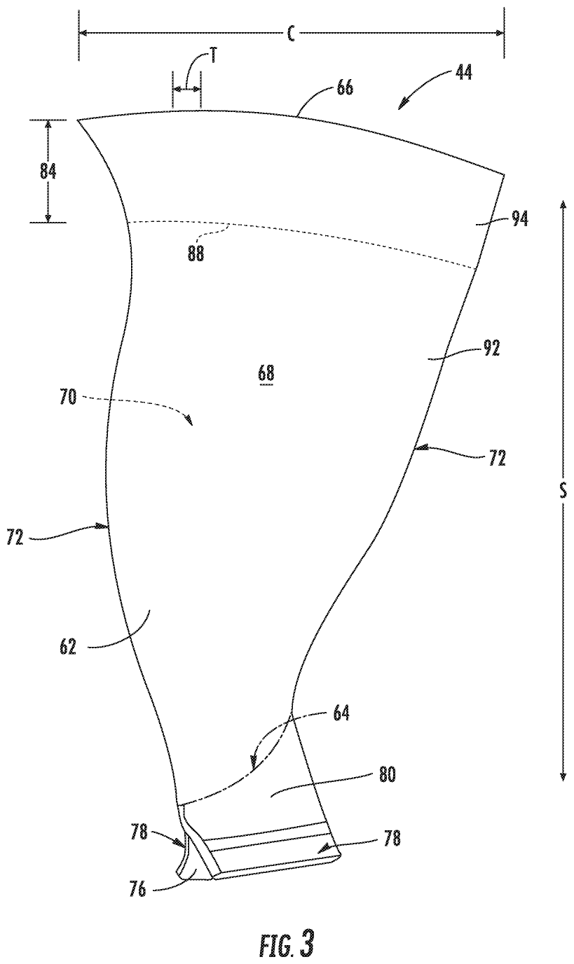

Referring to FIGS. 2 and 3, exemplary airfoil 62 embodiments are provided in the context of a fan blade 44. Although the illustrated airfoils 62 are shown as part of a fan blade 44, it is understood that the following discussion of an airfoil 62 may be equally applied to another airfoil embodiment, e.g., a stator vane or rotor blade of a compressor 22, 24 and/or turbine 28, 32 (see FIG. 1). As shown, each fan blade 44 extends radially outwardly along a span S from an airfoil root 64 to an airfoil tip 66. A pressure side 68 and a suction side 70 of the airfoil 62 extend from the airfoil's leading edge 72 to a trailing edge 74 and between the airfoil root 64 and airfoil tip 66 along the span S. Further, it should be recognized that airfoil 62 may define a chord C at each point along the span S between the airfoil root 64 and the airfoil tip 66. Further, the chord C may vary along the span of the airfoil 62. For instance, in the depicted embodiment, the chord C increases along the span S toward the airfoil tip 66. Though, in other embodiments, the chord C may be approximately constant throughout the span S or may decrease from the airfoil root 64 to the airfoil tip 66.

As shown particularly in FIG. 3, the airfoil 62 may define a thickness T extending between the pressure side 68 and the suction side 70 at each point along the span S. In certain embodiments, the thickness T may be approximately constant throughout the span S of the airfoil 62. In other embodiments, the airfoil 62 may define a variable thickness T between the airfoil root 64 and the airfoil tip 66. For instance, the thickness T may generally decrease along the span S toward the airfoil tip 66. Additionally, the airfoil 62 may define an approximately constant thickness T along the chord C at each point along the span S. Or, in other embodiments, at least one point along the span S of the airfoil 62 may define a variable thickness T along the chord C. For instance, the airfoil 62 may define a maximum thickness at a position along the chord C at each point along the span S.

Optionally, each fan blade 44 includes an integral component having an axial dovetail 76 with a pair of opposed pressure faces 78 leading to a transition section 80. When mounted within the gas turbine engine 10, as illustrated in FIG. 2, the dovetail 76 is disposed in a dovetail slot of the fan rotor disk 39, thereby attaching the fan blades 44 to the fan rotor 38.

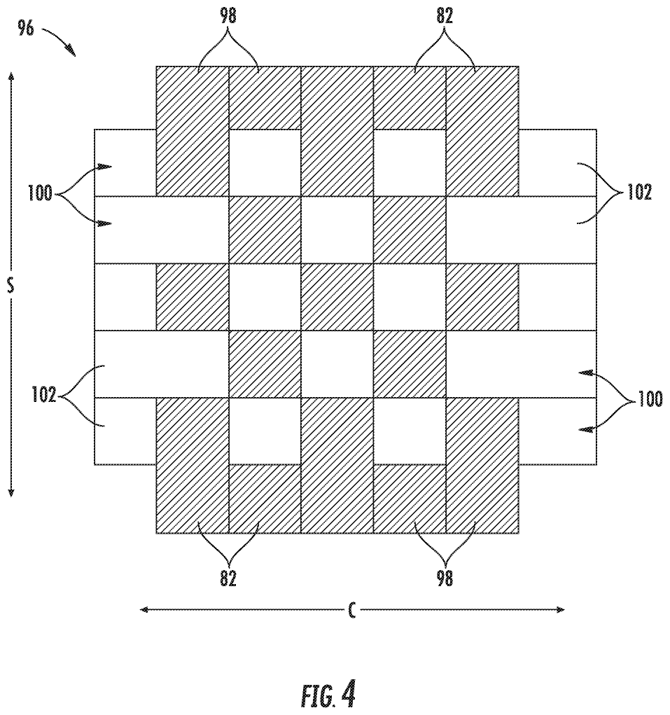

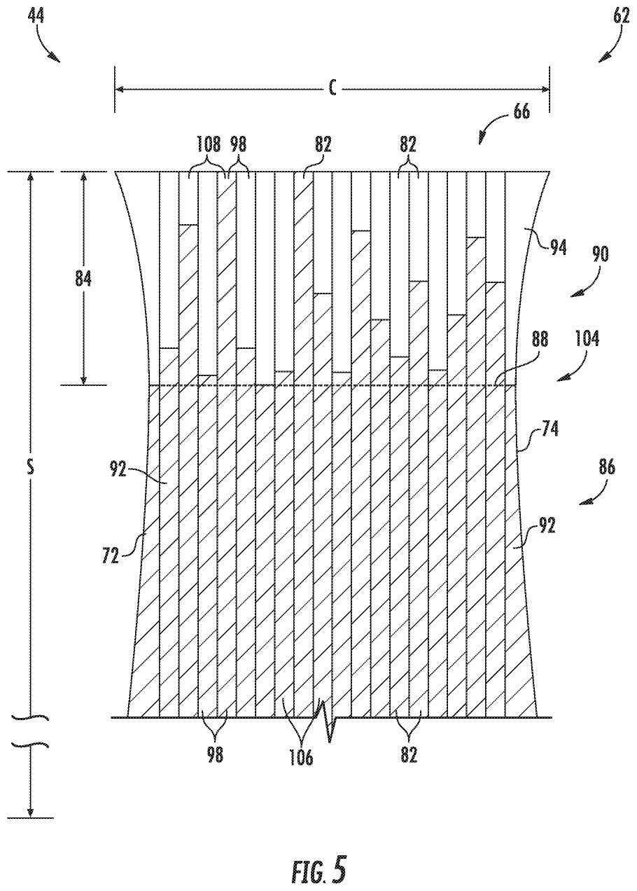

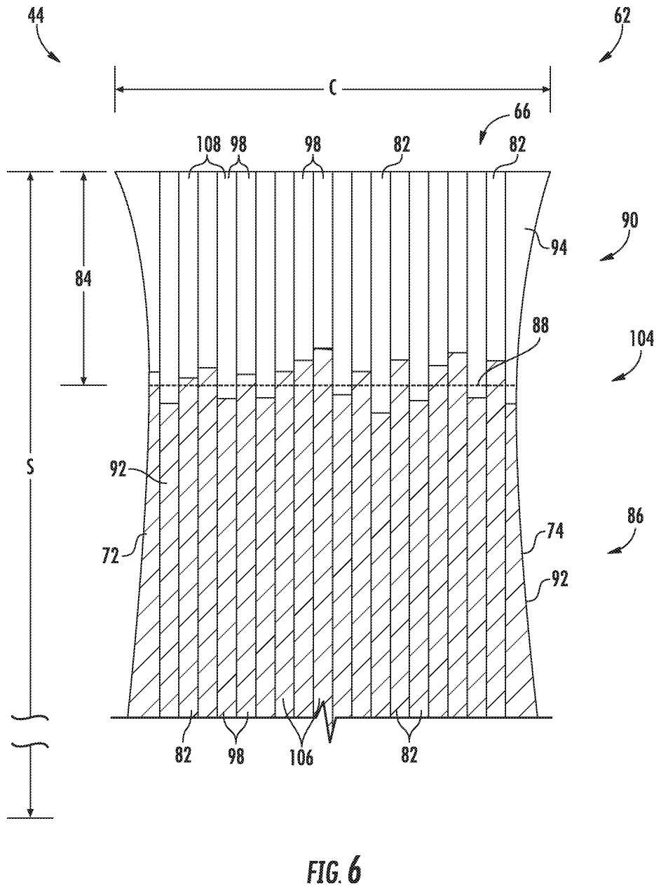

The airfoil 62 may include a plurality of spanwise fibers 82 (see, e.g., FIGS. 4-6) extending from the airfoil root 64 to the airfoil tip 66 and arranged between the leading edge 72 to the trailing edge 74. For instance, one or more spanwise fibers 82 may extend from the airfoil tip 66 to the airfoil root 64. Or, in further embodiments, one or more spanwise fibers 82 may be positioned in an end-to-end arrangement. For instance, two spanwise fibers 82 may be arranged end-to-end to extend along the span S from the airfoil root 64 to the airfoil tip 66. In another embodiment, two spanwise fibers 82 may overlap at their respective ends to extend along the span S. Though, in further embodiments, more than two spanwise fibers 82 may be arranged end-to-end and/or overlap to extend along the span S, such as three or more spanwise fibers 82. It should be appreciated that, though referred as spanwise fibers 82, the spanwise fibers 82 may extend approximately along the span S. For instance, the spanwise fibers 82 may extend within five degrees of the span S of the airfoil 62. Further, the airfoil 62 may include a matrix material 104 (see, e.g., FIGS. 5 and 6) surrounding the plurality of spanwise fibers 82. As such, the matrix material 104 may secure the plurality of spanwise fibers 82.

Further, the airfoil 62 may define a frangible line 88 separating a frangible airfoil portion 94 and a residual airfoil portion 92. The frangible airfoil portion 94 may generally be positioned toward the airfoil tip 66 and extend between the leading edge 72 and trailing edge 74 and between the airfoil tip 66 and the frangible line 88. The residual airfoil portion 92 may extend from the frangible line 88 to the airfoil root 64 along the span S. As explained in more detail in regards to FIGS. 5 and 6, the residual airfoil portion 92 may include a first portion 86 of the plurality of spanwise fibers 82. The first portion 86 of the plurality of spanwise fibers 82 may define a first stiffness. Further the frangible airfoil portion 94 may include spanwise fibers 82 defining a second stiffness. More particularly, the frangible airfoil portion 94 may include a second portion 90 of the plurality of spanwise fibers 82 (see, e.g., FIGS. 5 and 6). It should be appreciated that, in several embodiments, the second stiffness may be less than the first stiffness. It should also be recognized that one or more spanwise fibers 82 may be a part of both the first portion 86 of the plurality of spanwise fibers 82 and the second portion 90 of the plurality of spanwise fibers 82. For example, at least one spanwise fiber 82 may extend through the frangible line 88, such as a spanwise fiber 82 that extends the entire span S from the airfoil root 64 to the airfoil tip 66.

As further illustrated in FIG. 3, the frangible line 88 may generally extend along the chord C between the leading edge 72 and the trailing edge 74. It should be recognized that the frangible line 88 may generally extend along the chord C at approximately the same spanwise position. For instance, the frangible line 88 may extend parallel to the chord C at a point along the span S of the frangible line 88. In other embodiments, the frangible line 88 may at least partially extend radially inward or outward (e.g., along the span S) as the frangible line 88 extends axially along the chord C toward the trailing edge 74. For instance, in certain embodiments, the frangible line 88 may be defined along the chord C of one point along the span S. In other embodiments, the frangible line 88 may extend along a variable percentage of the span S from the leading edge 72 to the trailing edge 74. In one embodiment, the frangible airfoil portion 94 may extend along at least 10% of the span S from the airfoil tip 66, such as along a chord C at one point along the span S. More particularly, as illustrated, the frangible airfoil portion 94 may define a frangible height 84 extending between the airfoil tip 66 and the frangible line 88. As such, the frangible height 84 may extend along at least 10% of the span S between the leading edge 72 and the trailing edge 74. In another embodiment, the frangible airfoil portion 94 and/or the frangible height 84 may extend along at least 15% but less than 50% of the span S between the leading edge 72 and the trailing edge 74. The frangible airfoil portion 94 may have a reduced overall bending stiffness compared to the residual airfoil portion 92, as described in more detail below in regards to FIGS. 5 and 6.

Referring particularly to the exemplary airfoil 62 of FIG. 3, the airfoil 62 may be configured to fracture, break, or liberate at approximately the frangible line 88 up to the airfoil tip 66 (e.g., the frangible airfoil portion 94) following a loading or impact upon the airfoil 62. For example, the airfoil 62 configured as the fan blade 44 within the fan casing 40 or nacelle of the gas turbine engine 10 (FIG. 1) may be configured to detach, decouple, deform, break, or liberate the frangible airfoil portion 94 of the airfoil 62 at or above the frangible line 88. In one non-limiting example, the frangible airfoil portion 94 of the airfoil 62 may be defined as the difference in spanwise dimensions of the frangible airfoil portion 94 and the residual airfoil portion 92. For example, the frangible airfoil portion 94 may be defined within approximately 3% to approximately 15% of the total span S from the airfoil tip 66.

During operation of the gas turbine engine 10, such as following an event generating substantial imbalance in the fan rotor 38 or LP shaft 34, the frangible airfoil portion 94, e.g., of the fan blade 44, as shown and described in various embodiments in FIGS. 5 and 6 may be configured to deform or partially or fully detach from the remainder of the airfoil 62, e.g., along the frangible line 88. Further, the frangible airfoil portion 94 may detach while leaving all of or at least a portion of the residual airfoil portion 92. Events generating substantial unbalance in the fan rotor 38 and/or LP shaft 34 may include, but are not limited to, foreign object damage (e.g., bird strikes, ice ingestion, other debris, etc.) or fan blade 44 detachment. Detaching or decoupling the frangible airfoil portion 94 may reduce undesired unbalance or vibrations as the fan rotor 38 and/or LP shaft 34 continue to rotate. Furthermore, the embodiments of the airfoil 62 generally shown and described herein may enable a lighter fan casing 40 or nacelle, such as reducing an amount of metal materials or abradable material of the fan casing 40 or nacelle.

In one embodiment, the airfoil 62, the frangible airfoil portion 94, and/or residual airfoil portion 92 may include at least one composite. For instance, the airfoil 62 may be formed at least partially from a ceramic matrix composite. More particularly, in certain embodiments, the airfoil 62 may be formed from one or more composite spanwise fibers 82 configured as ceramic matrix composite weave.

Composite materials may include, but are not limited to, metal matrix composites (MMCs), polymer matrix composites (PMCs), or ceramic matrix composites (CMCs). Composite materials, such as may be utilized in the airfoil 62, generally comprise a fibrous reinforcement material embedded in matrix material, such as polymer, ceramic, or metal material. The reinforcement material serves as a load-bearing constituent of the composite material, while the matrix of a composite material serves to bind the fibers together and act as the medium by which an externally applied stress is transmitted and distributed to the fibers.

Exemplary CMC materials may include silicon carbide (SiC), silicon, silica, or alumina matrix materials and combinations thereof. Ceramic fibers may be embedded within the matrix, such as oxidation stable reinforcing fibers including monofilaments like sapphire and silicon carbide (e.g., Textron's SCS-6), as well as rovings and yarn including silicon carbide (e.g., Nippon Carbon's NICALON®, Ube Industries' TYRANNO®, and Dow Corning's SYLRAMIC®), alumina silicates (e.g., Nextel's 440 and 480), and chopped whiskers and fibers (e.g., Nextel's 440 and SAFFIL®), and optionally ceramic particles (e.g., oxides of Si, Al, Zr, Y, and combinations thereof) and inorganic fillers (e.g., pyrophyllite, wollastonite, mica, talc, kyanite, and montmorillonite). For example, in certain embodiments, bundles of the fibers, which may include a ceramic refractory material coating, are formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition. In certain embodiments, the thermal processing may take place in an autoclave.

Similarly, in various embodiments, PMC materials may be fabricated by impregnating a fabric or unidirectional tape with a resin (prepreg), followed by curing. For example, multiple layers of prepreg plies may be stacked to the proper thickness and orientation for the part, and then the resin may be cured and solidified to render a fiber reinforced composite part. As another example, a die may be utilized to which the uncured layers of prepreg may be stacked to form at least a portion of the composite component. The die may be either a closed configuration (e.g., compression molding) or an open configuration that utilizes vacuum bag forming. For instance, in the open configuration, the die forms one side of the blade (e.g., the pressure side 68 or the suction side 70). The PMC material is placed inside of a bag and a vacuum is utilized to hold the PMC material against the die during curing. In still other embodiments, the airfoil 62 may be at least partially formed via resin transfer molding (RTM), light resin transfer molding (LRTM), vacuum assisted resin transfer molding (VARTM), a forming process (e.g. thermoforming), or similar.

Prior to impregnation, the fabric may be referred to as a “dry” fabric and typically comprises a stack of two or more fiber layers. The fiber layers may be formed of a variety of materials, non-limiting examples of which include carbon (e.g., graphite), glass (e.g., fiberglass), polymer (e.g., Kevlar®) fibers, and metal fibers. Fibrous reinforcement materials can be used in the form of relatively short chopped fibers, generally less than two inches in length, and more preferably less than one inch, or long continuous fibers, the latter of which are often used to produce a woven fabric or unidirectional tape. Other embodiments may include other textile forms such as plane weave, twill, or satin.

In one embodiment, PMC materials can be produced by dispersing dry fibers into a mold, and then flowing matrix material around the reinforcement fibers. Resins for PMC matrix materials can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermoplastic resins include nylons, thermoplastic polyesters, polyaryletherketones, and polycarbonate resins. Specific examples of high performance thermoplastic resins that have been contemplated for use in aerospace applications include polyetheretherketone (PEEK), polyetherketoneketone (PEKK), polyetherimide (PEI), and polyphenylene sulfide (PPS). In contrast, once fully cured into a hard rigid solid, thermoset resins do not undergo significant softening when heated but, instead, thermally decompose when sufficiently heated. Notable examples of thermoset resins include epoxy, bismaleimide (BMI), and polyimide resins.

Referring now to FIG. 4, one embodiment of the spanwise fibers 82 is illustrated in accordance with aspects of the present subject matter. Particularly, FIG. 4 illustrates the spanwise fibers 82 configured in a woven fiber arrangement 96. More particularly, FIG. 4 illustrates a portion of a woven fiber arrangement 96 cut away. As depicted, in certain embodiments, the plurality of spanwise fibers 82 may be arranged in a plurality of toes. A toe is generally a bundle of thousands of continuous individual fibers held together and protected by an organic coating. For instance, the spanwise fibers 82 may be arranged in a plurality of spanwise toes 98. The spanwise toes 98 may generally extend along the span S (e.g., within five degrees of the span S). For example, one or more spanwise toes 98 may extend the full span S from the airfoil root 64 to the airfoil tip 66. In other embodiments, two or more spanwise toes 98 may be arranged end-to-end to extend along the span S. For instance, a spanwise toe 98 of the first portion 86 of spanwise fibers 82 may meet a spanwise toe 98 of the second portion 90 of spanwise fibers 82.

As further illustrated in FIG. 4, the airfoil 62 may further include a plurality of chordwise fibers 100. The chordwise fibers 100 may generally extend along the chord C between the leading edge 72 and the trailing edge 74 and arranged between the airfoil root 64 and the airfoil tip 66 (see, e.g., FIG. 3). It should be appreciated that, though referred as chordwise fibers 100, the chordwise fibers 100 may extend approximately along the chord C at each point along the span S. For instance, the chordwise fibers 100 may extend within five degrees of the chord C at each point along the span S of the airfoil 62. Moreover, the chordwise fibers 100 may also be arranged in a plurality of chordwise toes 102, each extending within five degrees of the chord C. Though, in other embodiments, it should be appreciated the chordwise fibers 100 may individually extend along the chord C. In one embodiment, the plurality of chordwise fibers 100 may be interwoven with the plurality of spanwise fibers 82 to define the woven fiber arrangement 96. It should be appreciated that interweaving the spanwise and chordwise toes 98, 102 may keep the fibers 82, 100 together and prevent delamination of the constituent fibers 82, 100. As such, a woven fiber arrangement 96 may increase the strength of the finished airfoil 62.

As shown, the spanwise toes 98 may be woven together with the chordwise toes 102. In certain embodiments, the spanwise toes 98 and the chordwise toes 102 may be braided together. Still, in other embodiments, the spanwise and chordwise toes 98, 102 may define a satin or twill woven fiber arrangement. It should be appreciated that the woven fiber arrangement 96 may include any arrangement that interweaves the spanwise toes 98 and the chordwise toes 102. For instance, one or more spanwise toes 98 may skip one or more chordwise toes 102 in the woven fiber arrangement 96. Similarly, one or more chordwise toes 102 may skip over one or more spanwise toes 98. In further embodiments, the woven fiber arrangement 96 may be a 3D or 2.5D woven fiber arrangement. For instance, one or more crosswise fibers (not shown) may extend between the pressure side 68 and suction side 70 and be interwoven with the spanwise and chordwise fibers 82, 100. More particularly, in certain embodiments, crosswise fibers may be arranged in crosswise toes and be interwoven into the woven fiber arrangement 96 including the spanwise and chordwise toes 98, 102.

Referring now to FIG. 5, the frangible airfoil portion 94 is illustrated in accordance with aspects of the present subject matter. Particularly, FIG. 5 illustrates a cross-section of the airfoil 62 along the chord C and the span S. As shown, the airfoil 62 includes the plurality of spanwise fibers 82 extending between the airfoil root 64 (FIG. 3) and the airfoil tip 66 and arranged between the leading edge 72 and the trailing edge 74. In the depicted embodiment, the spanwise fibers 82 are arranged in spanwise toes 98. Though, in other embodiments, the spanwise fibers 82 may individually extend along the span S. In still further embodiments, the spanwise fibers 82 may be arranged in one or more prepreg plies or unidirectional tapes. In the illustrated embodiment of FIG. 5, chordwise fibers 100 have been omitted for clarity. It should be appreciated that chordwise fibers 100 may extend between the leading edge 72 and trailing edge 74 (e.g., as chordwise toes 102) to define a woven fiber arrangement, such as the woven fiber arrangement 96 of FIG. 4. In certain embodiments, the airfoil 62 may only include the spanwise fibers 82 and/or the spanwise toes 98.

The airfoil 62 may further include a matrix material 104 surrounding the plurality of spanwise fibers 82. For example, the matrix material 104 may be infused between the plurality of spanwise fibers 82. As such, the matrix material 104 may secure the plurality of spanwise fibers 82. For instance, the matrix material 104 may harden during a process to form the composite component (e.g., during an autoclave or burn-out cycle). As such, the hardened matrix material 104 surrounding the spanwise fibers 82 may reduce relative motion between the spanwise fibers 82 while also transferring any loads acting on the airfoil 62 throughout the spanwise fibers 82. In embodiments with chordwise fibers 100, the matrix material 104 may further surround and secure the plurality of chordwise fibers 100.

The residual airfoil portion 92 may include the first portion 86 of the plurality spanwise fibers 82. For example, first portion 86 of spanwise fibers 82 may be arranged in a plurality of first toes 106. The first portion 86 of the plurality of spanwise fibers 82 may include a first stiffness (indicated by the first toes 106 including cross-hatching). The frangible airfoil portion 94 may include the second portion 90 of the plurality of spanwise fibers 82. Similar to the first portion 86, the second portion 90 of spanwise fibers 82 may be arranged in a plurality of second toes 108. The second portion 90 of the plurality of spanwise fibers 82 may define a second stiffness less than the first stiffness (indicated by the second toes 108 without cross-hatching). As such, the first portion 86 of plurality of spanwise fibers 82 may at least partially define a first overall bending stiffness of the residual airfoil portion 92. Similarly, the second portion 90 of the plurality of spanwise fibers 82 may at least partially define a second overall bending stiffness of the frangible airfoil portion 94. It should be appreciated that the first stiffness greater than the second stiffness, as described generally below, may cause the first overall bending stiffness to be higher than the second overall bending stiffness.

It should be appreciated that one of the second toes 108 defining the second stiffness that extends the farthest along the span S toward the airfoil root 64 may define the point along the span S of the frangible line 88. For instance, two or more second toes 108 including the second stiffness may extend to the same or approximately the same point along the span S and define the frangible line 88 extending along the chord C at the point along the span S of the frangible line 88. In the depicted embodiment, one or more of the plurality of spanwise fibers 82 may extend through the frangible line 88. As such, it should be recognized that such spanwise fibers 82 that extend through the frangible line 88 may be included in both the first portion 86 and the second portion 90 of the plurality of spanwise fibers 82. For example, as depicted, one more of the first toes 106 defining the first stiffness may extend through the frangible line 88, and thus also be second toes 108.

Still referring to FIG. 5, in one particular embodiment, at least one of the first portion 86 of the plurality of spanwise fibers 82 may define a first minimum fiber stiffness. For instance, one or more of the first portion 86 of the plurality of spanwise fibers 82 and/or first toes 106 may each define the first minimum fiber stiffness. In one particular embodiment, the first minimum fiber stiffness may be the first stiffness. For instance, each of the spanwise fibers 82 may define the first minimum fiber stiffness. Though, in other embodiments, one or more additional spanwise fibers (not shown) of the first portion 86 may define a fiber stiffness greater than the first minimum fiber stiffness. It should be appreciated that, in such an embodiment, spanwise fibers 82 defining the first minimum fiber stiffness may define the first fiber stiffness with the additional spanwise fiber(s) defining the fiber stiffness greater than the first minimum fiber stiffness. More particularly, the first fiber stiffness may be greater than the first minimum fiber stiffness but less than the fiber stiffness of the additional spanwise fiber(s).

Further, at least one of the second portion 90 of the plurality spanwise fibers 82 may define a second minimum fiber stiffness less than the first minimum fiber stiffness. In certain embodiments, one or more additional spanwise fibers of the second portion 90 may define a fiber stiffness greater than the second minimum fiber stiffness. For example, one or more spanwise fibers 82 (e.g., one or more first toes 106) may extend from the first portion 86, through the frangible line 88, and also be included in the second portion 90 of the plurality of spanwise fibers 82. As such, the additional spanwise fibers may define at least one of the first minimum fiber stiffness or the first fiber stiffness. The second minimum fiber stiffness may define the second fiber stiffness with the additional spanwise fibers defining a greater stiffness than the second minimum fiber stiffness. As such, the second fiber stiffness may be greater than the second minimum fiber stiffness but less than the fiber stiffness of the additional spanwise fibers (e.g., continuous fibers extending from the residual airfoil portion 92). More particularly, as illustrated, the first toes 106 defining the first stiffness and/or the first minimum stiffness may be switched out in the frangible airfoil portion 94 for the second toes 108 defining the second minimum stiffness. In certain embodiments, as shown in FIG. 5, the second toes 108 including the second minimum stiffness may gradually replace the second toes 108 including the first minimum stiffness and/or the first stiffness. As such, the second toes 108 may together define the second stiffness of the second portion 90 of the spanwise fibers 82 less than the first stiffness.

In one embodiment, at least one of the first portion 86 of the plurality of spanwise fibers 82 may include a composite fiber. In such an embodiment, at least one of the second portion 90 of the plurality of spanwise fibers 82 may include a glass or metal fiber. Generally, fibers formed from carbon may have an increased stiffness compared to fibers formed from glass or metal. As such, first toes 106 formed from carbon fibers may define the first stiffness greater than the second stiffness of second toes 108 including glass and/or metal fibers.

In other embodiments, a first fiber count of at least one of the first toes 106 (e.g., the cross-hatched first toes 106 of FIG. 5) may be higher than a second fiber count of at least one of the second toes 108 (e.g., the second toes 108 without cross-hatching in FIG. 5). Toes having a higher fiber count generally define a higher stiffness than toes with a lower fiber count. As such, the higher first fiber count in the first portion 86 of the plurality of fibers 82 may define the first stiffness greater than the second stiffness of the second portion 90 of the plurality of fibers 82 including second toes 108 with the lower second fiber count. Further, the first toes 106 including the first fiber count may at least partially define the first bending stiffness greater than the second bending stiffness defined at least partially by the second toes 108 including the second fiber count. In one such embodiment, the first fiber count may be at least six thousand fibers per toe, and the second fiber count may be less than six thousand fibers per toe. It should be appreciated that the first and second portions 86, 90 of the plurality of spanwise fibers 82 may include different fiber materials as well as different fiber counts as discussed generally above.

In certain embodiments, chordwise toes 102 may include at least one of the first or second fiber counts. The chordwise toes 102 may include the same fiber count through the span S of the airfoil 62. For instance, the chordwise toes 102 may each include the first fiber count. Though, in other embodiments, one more chordwise toes 102 may define a higher or lower fiber count. For instance, chordwise toes 102 may generally decrease in fiber count from the airfoil root 64 to the airfoil tip 66. In such an embodiment, reducing the fiber count of the chordwise toes 102 toward the airfoil tip 66 may also reduce the second overall bending stiffness relative to the first overall bending stiffness.

Referring now to FIG. 6, another embodiment of the frangible airfoil portion 94 is illustrated in accordance with aspects of the present subject matter. Particularly, FIG. 6 illustrates a cross-section of the airfoil 62 along the span S and the chord C of the airfoil 62. The spanwise fibers 82 of FIG. 6 may generally be configured the same or similarly to the spanwise fibers 82 of FIG. 5. For instance, the airfoil 62 of FIG. 6 may define the frangible airfoil portion 94 including the second toes 108 and the residual airfoil portion 92 including the first toes 106. However, as shown, all of the first toes 106 may be exchanged for the second toes 108 at approximately the frangible line 88. As such, the first portion 86 of the plurality of spanwise fibers 82 may each define the first fiber stiffness and/or the first minimum fiber stiffness. For instance, each of the first toes 106 may include the same fiber material and/or the same fiber count (e.g., represented by the cross-hatched first toes 106 in FIG. 6). Further, the second portion 90 of the plurality of spanwise fibers 82 may each define the second fiber stiffness and/or the second minimum fiber stiffness less than the first fiber stiffness. For example, each of the second toes 108 may include the same fiber material and/or the same fiber count (e.g., represented by the second toes 108 without cross-hatching in FIG. 6).

The first and second portions 86, 90 of the plurality of spanwise fibers 82 may meet at the frangible line 88. Further, the first portion 86 of the plurality of spanwise fibers 82 may generally be free of spanwise fibers 82 extending from the second portion 90 of the plurality of spanwise fibers 82. Similarly, the second portion 90 of the plurality of spanwise fibers 82 may generally be free of spanwise fibers 82 extending from the first portion 86 of the plurality of spanwise fibers 82. It should be recognized that even in such embodiments, one or more of the first portion 86 of the plurality of spanwise fibers 82 may extend nominally into the second portion 90 of the plurality of spanwise fibers 82 and vice versa. For instance, one or more of the first toes 106 may extend into the second portion 90 of spanwise fibers 82 by approximately 5% or less of the span S. Similarly, one or more of the second toes 108 may extend into the first portion 86 of spanwise fibers 82 by approximately 5% or less of the span S. It should be appreciated that the first and second toes 106, 108 may need to extend past the frangible line 88 by the nominal amount in order to properly weave or bread the spanwise toes 98 together.

Referring now generally to FIGS. 5 and 6, in certain embodiments, the residual airfoil portion 92 may define a portion of the airfoil 62 with the first overall bending stiffness. For instance, the first toes 106 defining the first stiffness may define the first overall bending stiffness with the matrix material 104 and/or any other additional spanwise fibers. Similarly, the frangible airfoil portion 94 may define a portion of the airfoil 62 with the second overall bending stiffness. For instance, the second toes 108 defining the second stiffness may define the second overall bending stiffness with the matrix material 104 and/or any other additional spanwise fibers.

As such, the second portion 90 of the plurality of spanwise fibers 82 may define the second overall bending stiffness along the span S less than the first overall bending stiffness of the first portion 86 of the plurality of spanwise fibers 82. More particularly, the first toes 106 of the residual airfoil portion 92 defining the higher first stiffness may lead to the increased bending stiffness of the residual airfoil portion 92 along the span S. Moreover, the frangible airfoil portion 94 may have a reduced bending stiffness along the span S allowing the frangible airfoil portion 94 to fracture, break, liberate, decouple, deform, deflect, etc. at or above the frangible line 88 as described above.

This written description uses exemplary embodiments to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An airfoil defining a span extending between a root and a tip and a chord at each point along the span extending between a leading edge and a trailing edge, the airfoil comprising:
a plurality of spanwise fibers extending between the root and the tip and arranged between the leading edge and the trailing edge;
a matrix material surrounding the plurality of spanwise fibers, wherein the matrix material secures the plurality of spanwise fibers;
a residual airfoil portion extending between the leading edge and the trailing edge and extending between the root and a frangible line along the span, the residual airfoil portion comprising a first portion of the plurality spanwise fibers, wherein the first portion of the plurality of spanwise fibers define a first stiffness; and
a frangible airfoil portion extending between the leading edge and the trailing edge and extending between the tip and the frangible line along the span, wherein the frangible airfoil portion comprises a second portion of the plurality of spanwise fibers, wherein the second portion of the plurality of spanwise fibers defines a second stiffness less than the first stiffness, and wherein the residual airfoil portion meets the frangible airfoil portion at the frangible line, the frangible line extending at least partially along the chord at a point along the span of the frangible line.

2. The airfoil of claim 1, wherein the frangible airfoil portion deforms or partially or fully detaches relative to the residual airfoil portion at the frangible line following an event creating imbalance.

3. The airfoil of claim 1, wherein the frangible line extends parallel to the chord at the point along the span of the frangible line.

4. The airfoil of claim 1, wherein the frangible line extends at least partially along the span.

5. The airfoil of claim 1, wherein the frangible airfoil portion extends along at least 10% of the span from the tip.

6. The airfoil of claim 1, wherein the frangible airfoil portion extends along at least 15% but less than 50% of the span from the tip.

7. The airfoil of claim 1, wherein the airfoil further comprises,
a plurality of chordwise fibers extending between the leading edge and the trailing edge and arranged between the root and the tip, wherein the matrix material further surrounds and secures the plurality of chordwise fibers, and wherein the plurality of chordwise fibers are interwoven with the plurality of spanwise fibers to define a woven fiber arrangement.

8. The airfoil of claim 1, wherein at least one of the plurality of spanwise fibers extends through the frangible line.

9. The airfoil of claim 1, wherein at least one of the first portion of the plurality of spanwise fibers defines a first minimum fiber stiffness, and wherein at least one of the second portion of the plurality spanwise fibers defines a second minimum fiber stiffness less than the first minimum fiber stiffness.

10. The airfoil of claim 1, wherein the first portion of the plurality of spanwise fibers each define the first fiber stiffness, and wherein the second portion of the plurality of spanwise fibers each define the second fiber stiffness less than the first fiber stiffness.

11. The airfoil of claim 1, wherein at least one of the first portion of the plurality of spanwise fibers comprises a composite fiber, and wherein at least one of the second portion of the plurality of spanwise fibers comprises a glass or metal fiber.

12. The airfoil of claim 1, wherein the first plurality of spanwise fibers are arranged in a plurality of first toes and the second plurality of spanwise fibers are arranged in a plurality of second toes, wherein a first fiber count of at least one of the first toes is higher than a second fiber count of at least one of the second toes.

13. The airfoil of claim 12, wherein the first fiber count is at least six thousand fibers per toe, and wherein the second fiber count is less than six thousand fibers per toe.

14. The airfoil of claim 1, wherein the airfoil is a fan blade of a gas turbine engine.

15. A gas turbine engine defining a central axis, the gas turbine engine comprising:
an engine shaft extending along the central axis;
a compressor attached to the engine shaft and extending radially about the central axis;
a combustor positioned downstream of the compressor to receive a compressed fluid therefrom;
a turbine mounted on the engine shaft downstream of the combustor to provide a rotational force to the compressor; and
a plurality of airfoils operably connected to the engine shaft, each of the plurality of airfoils defining a span extending between a root and a tip and a chord at each point along the span extending between a leading edge and a trailing edge, each airfoil comprising:
a plurality of spanwise fibers extending between the root and the tip and arranged between the leading edge and the trailing edge;
a matrix material surrounding the plurality of spanwise fibers, wherein the matrix material secures the plurality of radial fibers;
a residual airfoil portion extending between the leading edge and the trailing edge and extending between the root and a frangible line along the span, the residual airfoil portion comprising a first portion of the plurality spanwise fibers, wherein the first portion of the plurality of spanwise fibers defines a first stiffness; and
a frangible airfoil portion extending between the leading edge and the trailing edge and extending between the tip and the frangible line along the span, wherein the frangible airfoil portion comprises a second portion of the plurality of spanwise fibers, wherein the second portion of the plurality of spanwise fibers defines a second stiffness less than the first stiffness, and wherein the residual airfoil portion meets the frangible airfoil portion at the frangible line, the frangible line extending at least partially along the chord at a point along the span of the frangible line.

16. The gas turbine engine of claim 15, further comprising a fan section including the plurality of airfoils configured as fan blades.

17. The gas turbine engine of claim 15, wherein each airfoil further comprises,
a plurality of chordwise fibers extending between the leading edge and the trailing edge and arranged between the root and the tip, wherein the matrix material further surrounds and secures the plurality of chordwise fibers, and wherein the plurality of chordwise fibers are interwoven with the plurality of spanwise fibers to define a woven fiber arrangement.

18. The gas turbine engine of claim 15, wherein at least one of the first portion of the plurality of spanwise fibers defines a first minimum fiber stiffness, and wherein at least one of the second portion of the plurality of spanwise fibers defines a second minimum fiber stiffness less than the first minimum fiber stiffness.

19. The gas turbine engine of claim 15, wherein the first portion of the plurality of spanwise fibers each define the first fiber stiffness, and wherein the second portion of the plurality of spanwise fibers each define the second fiber stiffness less than the first fiber stiffness.

20. The gas turbine engine of claim 15, wherein the first plurality of spanwise fibers are arranged in a plurality of first toes and the second plurality of spanwise fibers are arranged in a plurality of second toes, wherein a first fiber count of at least one of the first toes is higher than a second fiber count of at least one the second toes.
